(19) United States
(12) Patent Application Publication
(10) Pub. No.: US 2026/0146901 A1
(43) Pub. Date: May 28, 2026

(54) PINCH SENSOR CABLE AND PINCHING DETECTION SYSTEM

(71) Applicant: Proterial, Ltd., Tokyo (JP)

(72) Inventor: Takahiro SUGIYAMA, Tokyo (JP)

(21) Appl. No.: 19/395,071

(22) Filed: Nov. 20, 2025

(30) Foreign Application Priority Data
Nov. 25, 2024 (JP) 2024-204668

(51) Int. Cl. G01L 1/00

(52) U.S. Cl. CPC G01L 1/005

(57) ABSTRACT

One aspect of the present disclosure provides a pinch sensor cable including a wire-shaped member, first through fourth covered wires, and a sheath. The covered wires are arranged around an outer circumference of the wire-shaped member such that a first midpoint coincides with a second midpoint in a transverse cross-section of the pinch sensor cable. The first covered wire is coupled, at a first end of the pinch sensor cable, to the second covered wire. The third covered wire is coupled, at the first end, to the fourth covered wire. The first midpoint corresponds to a midpoint between a center of the first covered wire and a center of the second covered wire in the transverse cross-section. The second midpoint corresponds to a midpoint between a center of the third covered wire and a center of the fourth covered wire in the transverse cross-section.

### CROSS-REFERENCE TO RELATED APPLICATIONS

The present application claims the benefit of Japanese Patent Application No. 2024-204668 filed on Nov. 25, 2024 with the Japan Patent Office, the entire disclosure of which is incorporated herein by reference.

### BACKGROUND

The present disclosure relates to a pinch sensor cable and a pinching detection system.

Japanese Patent No. 3275767 (hereinafter, referred to as '767 patent) discloses a pinch sensor cable, in which two or more electrode wires formed of conductive wires covered with a conductive material are spirally arranged and covered with a sheath thereon. When a hand or an article is pinched in a door, a pressing force is applied to a portion of the pinch sensor cable. When the portion of the pinch sensor cable is subjected to the pressing force, the electrode wires are electrically coupled with each other. As a result, it can be detected that the hand or the article is pinched in the door.

In this pinch sensor cable, the electrode wires are stranded together with a spacer and cut to a length corresponding to a sensor. The spacer is then drawn out, which forms a gap between the electrode wires.

The gap between the electrode wires makes it easier for the pinch sensor cable to deform when the pressing force is applied thereto. When no pressing force is applied to the pinch sensor cable, the electrode wires are not electrically coupled with each other due to the gap. When the pressing force is applied to the pinch sensor cable, the pinch sensor cable is deformed, and the electrode wires are electrically coupled with each other.

### SUMMARY

In the manufacture of the pinch sensor cable described above, it is necessary to prepare the electrode wires by covering each conductive wire with a conductive material. Additionally, it is also necessary to twist the electrode wires together with spacers and then draw out the spacers. Therefore, cost and labor required to manufacture the pinch sensor cable disclosed in the '767 patent are high.

It is desirable that one aspect of the present disclosure can achieve a reduction in manufacturing cost and labor for a pinch sensor cable.

One aspect of the present disclosure may provide a pinch sensor cable that comprises a wire-shaped member (or a wire-shaped core), first through fourth covered wires, and a sheath.

The wire-shaped member may be deformable in a radial direction of the pinch sensor cable.

The first through fourth covered wires may be arranged around an outer circumference of the wire-shaped member such that a first midpoint coincides with a second midpoint in a transverse cross-section of the pinch sensor cable. Each of the first through fourth covered wires may include at least one conductive wire covered with an insulator. The first covered wire may be coupled (or connected), at a first end of the pinch sensor cable, to the second covered wire. The third covered wire may be coupled (or connected), at the first end of the pinch sensor cable, to the fourth covered wire. The first midpoint may correspond to a midpoint between a center of the first covered wire and a center of the second covered wire in the transverse cross-section. The second midpoint may correspond to a midpoint between a center of the third covered wire and a center of the fourth covered wire in the transverse cross-section.

The sheath (i) may have elastic and insulating properties and (ii) may cover the wire-shaped member and the first through fourth covered wires.

Such a pinch sensor cable may achieve a reduction in manufacturing cost and labor for the pinch sensor cable.

### BRIEF DESCRIPTION OF THE DRAWINGS

Example embodiments of the present disclosure will be described hereinafter with reference to the accompanying drawings, in which:

FIG. 1 is a plan view showing a configuration of a pinching detection system according to a first embodiment;

FIG. 2 is a transverse cross-sectional view of a pinch sensor cable taken along line II-II in FIG. 1;

FIG. 3 is a transverse cross-sectional view of the pinch sensor cable taken along line III-III in FIG. 1;

FIG. 4 is a circuit diagram showing an electrical configuration of an input pulse generator and a crosstalk detector;

FIG. 5 is a graph showing results of crosstalk measured in the pinching detection system;

FIG. 6 is a graph showing input pulses obtained by simulation;

FIG. 7 is a graph showing the crosstalk obtained by simulation;

FIG. 8 is a circuit diagram showing an electrical configuration of an input pulse generator and a crosstalk detector according to a second embodiment;

FIG. 9 is a transverse cross-sectional view of a pinch sensor cable according to a third embodiment; and

FIG. 10 is a transverse cross-sectional view of a pinch sensor cable according to a fourth embodiment.

### DETAILED DESCRIPTION OF EXEMPLARY EMBODIMENTS

Some specific example embodiments of the present disclosure will be described below. These specific example embodiments are provided merely to facilitate a better understanding of the present disclosure and are not intended to limit the present disclosure.

### 1. First Embodiment

The first embodiment provides a pinching detection system 1, which will be described below.

### 1-1. Configuration of Pinching Detection System

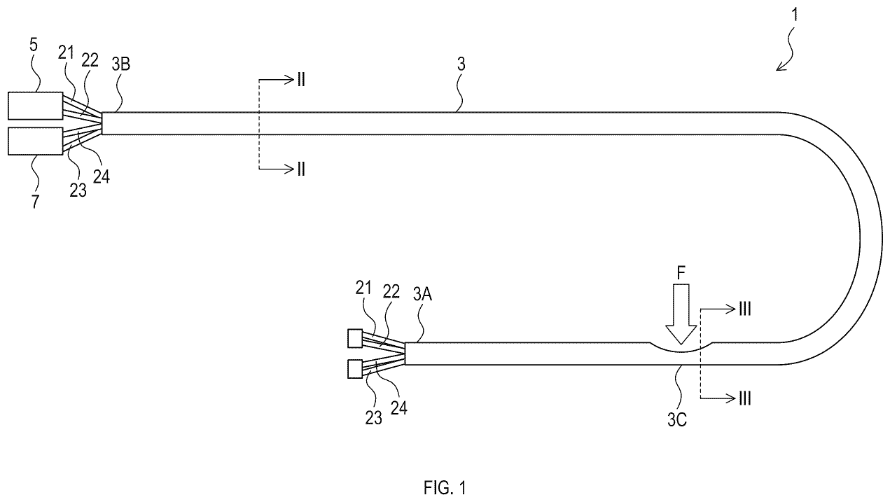

As shown in FIG. 1, the pinching detection system 1 comprises a pinch sensor cable 3, an input pulse generator 5, and a crosstalk detector 7.

The pinch sensor cable 3 is in the form of an elongated member. A length of the pinch sensor cable 3 may be within, but is not limited to, a range from one meter to several tens of meters. A diameter of the pinch sensor cable 3 may be within, but is not limited to, a range from 4 millimeters to 6 millimeters.

### 1-2. Details of Pinch Sensor Cable

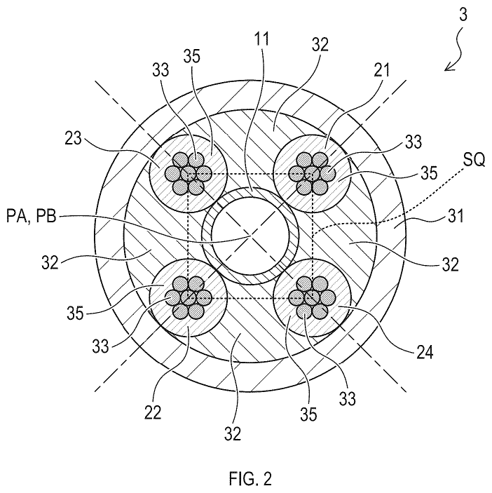

FIG. 2 shows a transverse cross-section of the pinch sensor cable 3 taken along line II-II in FIG. 1. The transverse cross-section is a cross section perpendicular to a longitudinal direction of the pinch sensor cable 3 (i.e., a cross section along the diameter of the pinch sensor cable 3).

As shown in FIG. 2, the pinch sensor cable 3 comprises a wire-shaped member 11, first through fourth covered wires 21 through 24, and a sheath (or an elastic insulating member, or a cable jacket, or an outermost protective layer) 31.

The wire-shaped member 11 extends from a first end 3A of the pinch sensor cable 3 in the longitudinal direction of the pinch sensor cable 3 to a second end 3B of the pinch sensor cable 3 opposite the first end 3A. The wire-shaped member 11 may be, but is not limited to, deformable in a radial direction of the wire-shaped member 11. In the first embodiment, the wire-shaped member 11 may be, but is not limited to, a hollow tube. When a pressing force F is not applied to the pinch sensor cable 3, the shape of the wire-shaped member 11 in the transverse cross-section may be, but is not limited to, circular. The pressing force F is a force in a direction of crushing the pinch sensor cable 3 in a radial direction thereof. Examples of the material of the wire-shaped member 11 include, but are not limited to, resin and rubber. The wire-shaped member 11 may be, but is not limited to, a tube made of polyethylene. In another embodiment, the wire-shaped member 11 may be made of foamed resin. The foamed resin may be spongy. The diameter of the wire-shaped member 11 may be within, but is not limited to, a range from 1.0 millimeter to 4.6 millimeters. The thickness of the wire-shaped member (tube) 11 may be within, but is not limited to, a range from 0.05 millimeter to 0.5 millimeter.

The first through fourth covered wires 21 through 24 extend from the first end 3A to the second end 3B. As shown in FIG. 2, the first covered wire 21 comprises conductive wires 33 and an insulator 35. One of the conductive wires 33 is disposed in the center of the first covered wire 21 in the transverse cross-section. The insulator 35 covers the conductive wires 33. Examples of the material of the conductive wires 33 include, but are not limited to, copper and aluminum. Examples of the conductive wires 33 include, but are not limited to, stranded wires formed of seven strands twisted together. Examples of the material of the insulator 35 include, but are not limited to, resin and rubber. The resin or rubber used for the insulator 35 may be an olefinic or styrene thermoplastic elastomer composition that does not require a cross-linking process, or may be a rubber-based composition made of cross-linked ethylene-propylene-diene copolymer. Each of the second through fourth covered wires 22 through 24 also has the same configuration as that of the first covered wire 21. At least one of the first through fourth covered wires 21 through 24 may comprise a single conductive wire in place of the conductive wires 33.

For example, each of the first through fourth covered wires 21 through 24 has a circular shape in the transverse cross-section. The first through fourth covered wires 21 through 24 may have the same diameter. The diameter of each of the first through fourth covered wires 21 through 24 may be within, but is not limited to, a range from 0.5 millimeter to 1.0 millimeter.

The first through fourth covered wires 21 through 24 are provided around an outer circumference of the wire-shaped member 11. The first through fourth covered wires 21 through 24 may be in contact with an outer circumferential surface of the wire-shaped member 11. In the transverse cross-section, the first through fourth covered wires 21 through 24 may be equally spaced along a circumferential direction of the wire-shaped member 11.

For example, the first through fourth covered wires 21 through 24 are each arranged spirally about the wire-shaped member 11. Specifically, assuming that a point on the first covered wire 21 travels along the first covered wire 21, that point rotates about the wire-shaped member 11 as the point travels in the longitudinal direction of the pinch sensor cable 3. A spiral pitch (or a helical pitch), an axial distance that the point travels in the longitudinal direction of the pinch sensor cable 3 for one full rotation about the wire-shaped member 11, may be within, but is not limited to, a range from 5 millimeters to 25 millimeters. Such a spiral arrangement is also applied to the second through fourth covered wires 22 through 24.

In the transverse cross-section, the first covered wire 21 is opposite the second covered wire 22 across the wire-shaped member 11. In other words, the first covered wire 21 is radially aligned with the second covered wire 22 across the wire-shaped member 11. The third covered wire 23 is opposite the fourth covered wire 24 across the wire-shaped member 11. In other words, the third covered wire 23 is radially aligned with the fourth covered wire 24 across the wire-shaped member 11.

A midpoint between a center of the first covered wire 21 and a center of the second covered wire 22 in the transverse cross-section is referred to as a first midpoint PA. A midpoint between a center of the third covered wire 23 and a center of the fourth covered wire 24 is referred to as a second midpoint PB.

The first midpoint PA is located on one straight line passing through the center of the first covered wire 21 and the center of the second covered wire 22. A distance from the first midpoint PA to the center of the first covered wire 21 is equal to a distance from the first midpoint PA to the center of the second covered wire 22. The second midpoint PB is located on one straight line passing through the center of the third covered wire 23 and the center of the fourth covered wire 24. A distance from the second midpoint PB to the center of the third covered wire 23 is equal to a distance from the second midpoint PB to the center of the fourth covered wire 24.

In a portion of the pinch sensor cable 3 where the pressing force F is not applied, the first midpoint PA coincides with the second midpoint PB in the transverse cross-section. In the portion where the pressing force F is not applied, the first through fourth covered wires 21 through 24 may be arranged on/around the outer circumference of the wire-shaped member 11 such that the first through fourth covered wires 21 through 24 are located at four respective vertices of a single virtual square SQ in the transverse cross-section.

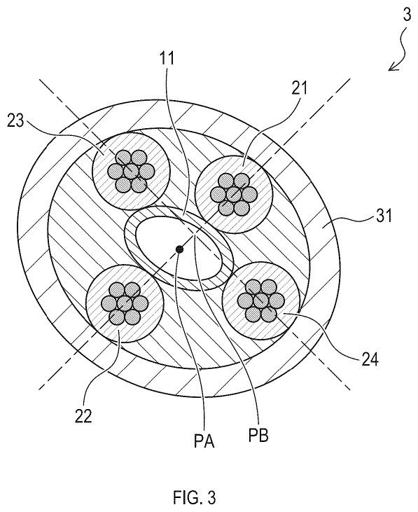

As shown in FIG. 1, when the pressing force F is applied to a portion 3C of the pinch sensor cable 3, the portion 3C is deformed. The portion 3C is any part of the pinch sensor cable 3. FIG. 3 shows a transverse cross-section of the portion 3C. In the portion 3C, the wire-shaped member 11 and the sheath 31 are radially deformed, and respective positions of the first through fourth covered wires 21 through 24 are shifted from the respective positions when no pressing force F is applied. As a result, the first midpoint PA and the second midpoint PB do not coincide with each other in the transverse cross-section of the portion 3C.

The sheath 31 extends from the first end 3A to the second end 3B. The sheath 31 is a hollow tubular member having elastic and insulating properties. The sheath 31 covers the wire-shaped member 11 and the first through fourth covered wires 21 through 24. Thus, the wire-shaped member 11 and the first through fourth covered wires 21 through 24 are positioned inside the sheath 31.

The sheath 31 is elastically deformed in the radial direction of the pinch sensor cable 3 when the pressing force F is applied. Thus, as shown in FIG. 3, in the portion 3C, the sheath 31 is deformed in the radial direction of the pinch sensor cable 3. The thickness of the sheath 31 may be within, but is not limited to, a range from 0.2 millimeter to 0.4 millimeter. Examples of the material of the sheath 31 include, but are not limited to, resin and rubber, and more specifically, an olefinic or styrene thermoplastic elastomer composition, and a rubber-based composition made of cross-linked ethylene-propylene-diene copolymers.

As shown in FIG. 2, portions radially outward from the wire-shaped member 11 and radially inward from the sheath 31 in the transverse cross-section are referred to as intermediate portions 32. The intermediate portions 32 are located between the first covered wire 21 and the fourth covered wire 24, between the fourth covered wire 24 and the second covered wire 22, between the second covered wire 22 and the third covered wire 23, and between the third covered wire 23 and the first covered wire 21, respectively.

The intermediate portions 32 each contain a gap filler, for example. Examples of the gap filler include a soft member such as spun yarn or resin string. In this case, the first through fourth covered wires 21 through 24 are embedded in the gap fillers.

For example, when the pinch sensor cable 3 is manufactured, the gap fillers are twisted together with the first through fourth covered wires 21 through 24. The gap fillers do not have to be drawn out and may be left in place.

For example, when the pinch sensor cable 3 is manufactured, the sheath 31 may be provided after a tape is wound around a bundle of the first through fourth covered wires 21 through 24. In this case, the sheath 31 can be disposed with the first through fourth covered wires 21 through 24 held in place.

A gap may or may not be provided between the sheath 31 and each of the first through fourth covered wires 21 through 24.

As shown in FIG. 1, at the first end 3A, the first covered wire 21 is directly coupled (i.e., shorted) to the second covered wire 22. At the first end 3A, the third covered wire 23 is directly coupled (i.e., shorted) to the fourth covered wire 24. The input pulse generator 5 is (i) coupled, at the second end 3B, to the first covered wire 21 and to the second covered wire 22 and (ii) configured to repeatedly generate an input pulse 37. The crosstalk detector 7 is (i) coupled, at the second end 3B, to the third covered wire 23 and to the fourth covered wire 24 and (ii) configured to detect crosstalk 39 between the third covered wire 23 and the fourth covered wire 24.

The first covered wire 21 may be coupled, at the first end 3A, to the second covered wire 22 through a resistor with several ohms to several tens of ohms. Additionally or alternatively, the third covered wire 23 may be coupled, at the first end 3A, to the fourth covered wire 24 through a resistor with several ohms to several tens of ohms.

### 1-3. Details of Input Pulse Generator and Crosstalk Detector

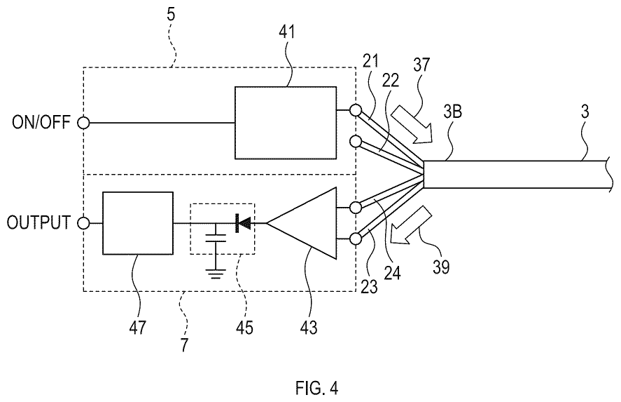

As shown in FIG. 4, the input pulse generator 5 comprises a timer circuit 41. Examples of the timer circuit 41 include, but are not limited to, a timer IC, more specifically, a TLC555 available from Texas Instruments Incorporated. In another embodiment, the input pulse generator 5 may include any type of an oscillator, in place of the timer circuit 41. Examples of the oscillator include, but are not limited to, an LC oscillator, more specifically, a Colpitts oscillator, a Hartley oscillator, and a Clapp oscillator.

The crosstalk detector 7 comprises an operational amplifier 43, a rectifier circuit 45, and a comparator 47.

The operational amplifier 43 comprises a pair of input terminals coupled to the third covered wire 23 and to the fourth covered wire 24. The crosstalk between the third covered wire 23 and the fourth covered wire 24 is amplified by the operational amplifier 43. The operational amplifier 43 may be an open-loop configuration with no negative feedback circuit from its output to its input, or may be a closed-loop configuration with such a negative feedback circuit.

The amplified crosstalk is converted into an equivalent amplitude for the crosstalk, using the rectifier circuit 45. More specifically, the rectifier circuit 45 is configured (i) to rectify the crosstalk and (ii) to smooth the rectified crosstalk. The voltage of the smoothed crosstalk corresponds to the equivalent amplitude for the crosstalk. When this equivalent amplitude exceeds a certain threshold, the comparator 47 asserts a detection signal, and thus the pinching is detected. In the first embodiment, the detection signal is a positive logic signal (or an active high signal). In another embodiment, the detection signal may be a negative logic signal (or an active low signal).

### 1-4. Example Applications of Pinching Detection System

Examples of applications for which the pinching detection system 1 as configured above is applicable include, but are not limited to, a sliding door of a vehicle and a train door.

The pinch sensor cable 3 may be mounted along a door frame of the sliding door of the vehicle or the train door.

Accordingly, the pinching detection system 1 may detect that an object such as a hand, an article, or the like is pinched in the sliding door of the vehicle or the train door.

### 1-5. Technical Effects of First Embodiment

The first embodiment as detailed above can achieve the following first through seventh technical effects.

### 1-5-1. First Technical Effect

In a case in which no pressing force F is applied to any portion of the pinch sensor cable 3, the first midpoint PA and the second midpoint PB coincide with each other in the transverse cross-section of any portion of the pinch sensor cable 3, as shown in FIG. 2. Therefore, even when the input pulse generator 5 generates the input pulse 37, the voltage of the crosstalk 39 detected by the crosstalk detector 7 is low.

In contrast, in a case in which the portion 3C is deformed by the pressing force F applied to the portion 3C due to a hand or an article being caught in the door, the first midpoint PA and the second midpoint PB in the transverse cross-section in the portion 3C do not coincide with each other, as shown in FIG. 3. Thus, the voltage of the crosstalk 39 detected by the crosstalk detector 7 increases. Accordingly, the pinching detection system 1 can detect that the pressing force F is applied to any portion in the pinch sensor cable 3 (i.e., that a hand or an article is pinched in the door) based on the voltage of the crosstalk 39 detected by the crosstalk detector 7.

In addition, in the pinching detection system 1, the voltage of the crosstalk 39 increases in response to an increase in the frequency of the input pulse 37, and thus the detection sensitivity of the pinch sensor cable 3 increases.

In the present disclosure, the first midpoint PA and the second midpoint PB coinciding with each other are not necessarily limited to exactly coinciding with each other. For example, as long as the crosstalk 39 when no pressing force F is applied to any portion of the pinch sensor cable 3 is low enough to not significantly inhibit detection of the pressing force F, the first midpoint PA and the second midpoint PB may be misaligned.

### 1-5-2. Second Technical Effect

In the first embodiment, in the manufacture of the pinch sensor cable 3, it is not necessary to blend a conductive filler such as carbon black in the insulator 35 of each of the first through fourth covered wires 21 through 24, as disclosed in the '767 patent. In addition, (i) a process of preparing a spacer and (ii) a process of removing the spacer, which are required in the '767 patent, can be eliminated. Therefore, the cost and labor required to manufacture the pinch sensor cable 3 can be reduced.

### 1-5-3. Third Technical Effect

In the '767 patent, when a pressing force F is applied to a portion of the cable, the pressing force F cannot be detected until internal electrode wires come into contact with each other. In contrast, even when the amount of deformation is small, the pinching detection system 1 can detect the crosstalk 39 having a voltage corresponding to the amount of deformation caused by the pressing force F applied to the portion 3C. Therefore, the pinching detection system 1 can detect the pressing force F with high sensitivity.

### 1-5-4. Fourth Technical Effect

The amount of deformation in the portion 3C increases as the pressing force F applied to portion 3C increases. The misalignment between the first midpoint PA and the second midpoint PB increases as the amount of deformation in the portion 3C increases, resulting in an increase in the voltage of the crosstalk 39. Thus, the voltage of the crosstalk 39 increases as the pressing force F applied to the portion 3C increases. Therefore, the pinching detection system 1 can be used to determine a magnitude of the pressing force F applied to the portion 3C based on the voltage of the crosstalk 39.

For example, in a case in which the pinching detection system 1 is used for a sliding door of a vehicle or a door of a train, the magnitude of the pressing force F applied to the portion 3C can be determined based on the voltage of the crosstalk 39, and further, the sliding door of the vehicle or the train door can be controlled with excellent responsiveness, depending on the magnitude of the pressing force F determined.

### 1-5-5. Fifth Technical Effect

The first through fourth covered wires 21 through 24 are arranged spirally about the wire-shaped member 11. In this case, regardless of the position of the portion 3C to which the pressing force F is applied, there is a portion of the pinch sensor cable 3 near the portion 3C where the misalignment between the first midpoint PA and the second midpoint PB tends to increase. Thus, the pinching detection system 1 can detect the pressing force F with high sensitivity, regardless of the position of the portion 3C to which the pressing force F is applied.

### 1-5-6. Sixth Technical Effect

In the transverse cross-section, the first through fourth covered wires 21 through 24 are arranged at the respective vertices of the virtual square SQ. Thus, the voltage of the crosstalk 39 when no pressing force F is applied to any portion of the pinch sensor cable 3 can be further suppressed.

### 1-5-7. Seventh Technical Effect

The wire-shaped member 11, which is in the form of a hollow tube, is more easily deformed when the pressing force F is applied to the portion 3C, and the misalignment between the first midpoint PA and the second midpoint PB becomes greater. Thus, the pinching detection system 1 can have a higher detection sensitivity to the pressing force F.

### 1-6. Verification Test

The inventor measured (i) the crosstalk 39 occurred when no pressing force F was applied to any portion of the pinch sensor cable 3, and (ii) the crosstalk 39 occurred when the pressing force F was applied to the portion 3C by pinching the portion 3C with pliers.

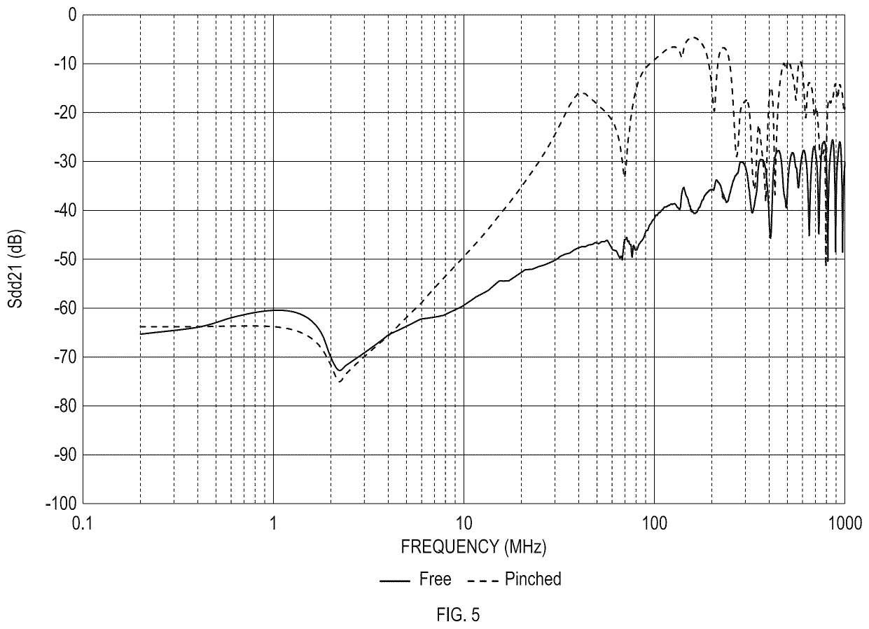

FIG. 5 shows the results of those measurements. A vertical axis in FIG. 5 represents the magnitude of the crosstalk 39. “Free”, defined by a solid line, is the result of the measurement performed when no pressing force F was applied to any portion of the pinch sensor cable 3. “Pinched”, defined by a dashed line, is the result of the measurement performed when the pressing force F was applied to the portion 3C by pinching the portion 3C with pliers.

Based on these measurements, the inventor performed a pulse response simulation using a circuit model. One cycle of the pulse was 500 nanoseconds. An impedance of a drive circuit was 50 ohms. An impedance on a crosstalk detection side was 250 ohms.

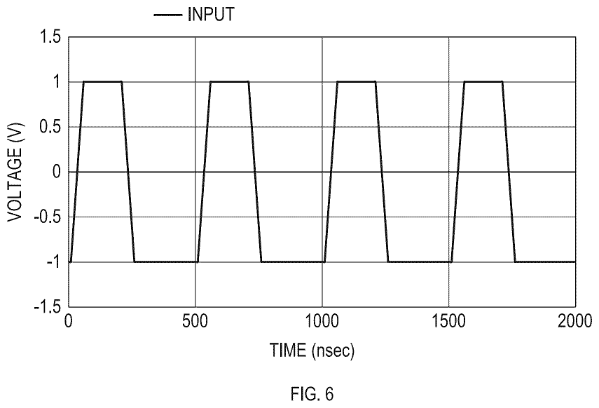

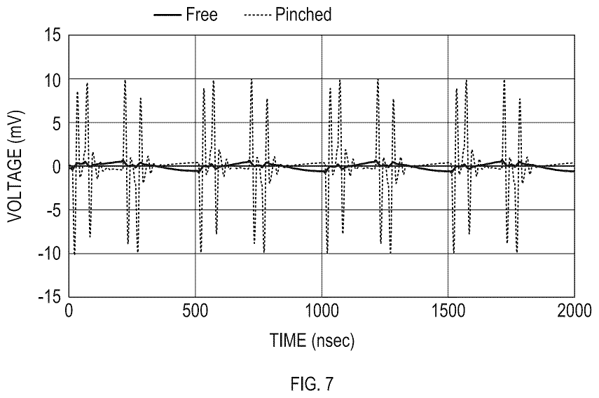

FIG. 6 shows the input pulses 37 obtained by simulation. FIG. 7 shows the crosstalk 39 obtained by simulation. FIG. 7 shows the crosstalk 39 indicated as “Free”, which is defined by the solid line, and the crosstalk 39 indicated as “Pinched”, which is defined by the dashed line. The crosstalk 39 indicated as “Pinched” had a significantly high output voltage compared to that of the crosstalk 39 indicated as “Free”. The results of the simulations verify that the pinching detection system 1 can detect the pressing force F.

### 2. Further Embodiments

### 2-1. Second Embodiment

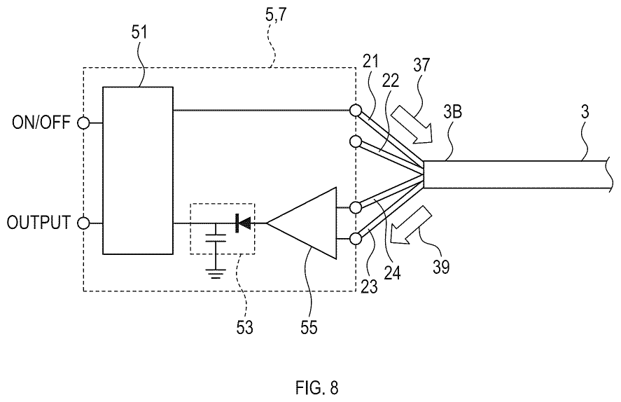

As shown in FIG. 8, the input pulse generator 5 and the crosstalk detector 7 may be an integrated device. This device comprises a microcomputer 51, a rectifier circuit 53, and an operational amplifier 55.

### 2-2. Third Embodiment

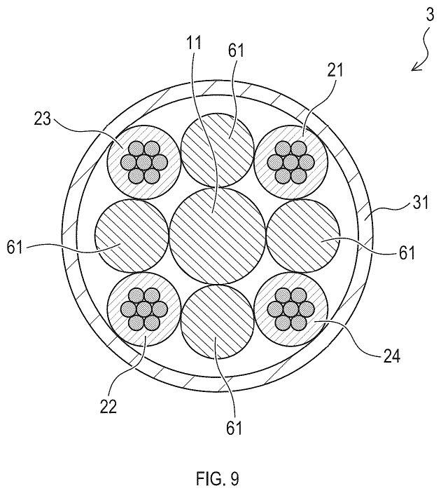

The pinch sensor cable 3 may be configured as shown in FIG. 9. In this configuration, the wire-shaped member 11 is formed of a gap filler. The gap filler is spun yarn, for example. The pinch sensor cable 3 comprises four gap fillers 61. The gap fillers 61 are provided in the transverse cross-section between the first covered wire 21 and the fourth covered wire 24, between the fourth covered wire 24 and the second covered wire 22, between the second covered wire 22 and the third covered wire 23, and between the third covered wire 23 and the first covered wire 21, respectively. The gap fillers 61 are spun yarn, for example.

### 2-3. Fourth Embodiment

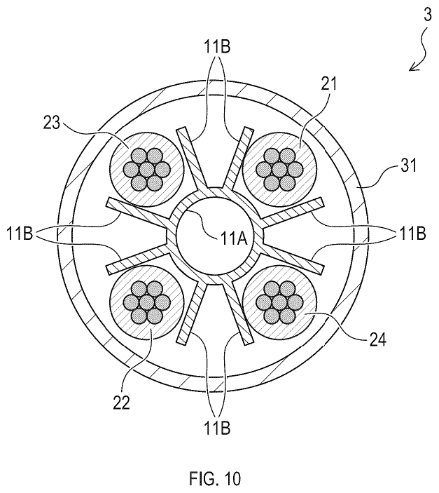

The pinch sensor cable 3 may be configured as shown in FIG. 10. In this configuration, the wire-shaped member 11 is a gap filler made of resin. The wire-shaped member 11 comprises a hollow, pipe-shaped center portion 11A and eight partition walls 11B that extend outwardly from the center portion 11A. The eight partition walls 11B are spaced along a circumferential direction of the center portion 11A in the transverse cross-section. The thickness of each of the center portion 11A and the partition walls 11B may be within, but is not limited to, a range from 0.05 millimeter to 0.5 millimeter. The center portion 11A and the partition walls 11B may have the same thickness or different thicknesses. Thus, the thickness of the center portion 11A may be smaller or greater than the thickness of each of the partition walls 11B.

Of the eight partition walls 11B, two partition walls 11B are provided between the first covered wire 21 and the fourth covered wire 24, two between the fourth covered wire 24 and the second covered wire 22, two between the second covered wire 22 and the third covered wire 23, and the remaining two between the third covered wire 23 and the first covered wire 21.

### 2-4. Fifth Embodiment

The wire-shaped member 11 may be a string member made of resin. In this case, when the pressing force F is applied to the portion 3C, the wire-shaped member 11 is more easily deformed and the misalignment between the first midpoint PA and the second midpoint PB becomes greater. This makes it possible to increase the detection sensitivity of the pinching detection system 1 to the pressing force F.

### 3. Supplementary Explanation

Although the embodiments of the present disclosure have been described so far, the present disclosure can take various forms without being limited to the above-described embodiments.

Two or more functions achieved by one element of the above-described embodiments may be achieved by two or more elements. One function achieved by one element may be achieved by two or more elements. Two or more functions achieved by two or more elements may be achieved by one element. One function achieved by two or more elements may be achieved by one element. A part of the configurations in the above-described embodiments may be omitted. At least a part of the configurations in the above-described embodiments may be added to or replaced with another part of the configurations in the above-described embodiments.

What is claimed is:

1. A pinch sensor cable, comprising:
a wire-shaped member deformable in a radial direction of the pinch sensor cable;
first through fourth covered wires arranged around an outer circumference of the wire-shaped member such that a first midpoint coincides with a second midpoint in a transverse cross-section of the pinch sensor cable, each of the first through fourth covered wires including at least one conductive wire covered with an insulator, the first covered wire being coupled, at a first end of the pinch sensor cable, to the second covered wire, the third covered wire being coupled, at the first end of the pinch sensor cable, to the fourth covered wire, the first midpoint corresponding to a midpoint between a center of the first covered wire and a center of the second covered wire in the transverse cross-section, the second midpoint corresponding to a midpoint between a center of the third covered wire and a center of the fourth covered wire in the transverse cross-section; and
a sheath (i) having elastic and insulating properties and (ii) covering the wire-shaped member and the first through fourth covered wires.

2. The pinch sensor cable according to claim 1, wherein
the first covered wire is aligned with the second covered wire across the wire-shaped member in the radial direction in the transverse cross-section when no pressing force is applied to the pinch sensor cable, and
the third covered wire is aligned with the fourth covered wire across the wire-shaped member in the radial direction in the transverse cross-section when no pressing force is applied to the pinch sensor cable.

3. The pinch sensor cable according to claim 1, wherein
the first through fourth covered wires are arranged around the outer circumference of the wire-shaped member so as to be located at four respective vertices of a virtual square in the transverse cross-section when no pressing force is applied to the pinch sensor cable.

4. The pinch sensor cable according to claim 1, wherein
the wire-shaped member is a hollow tube, or a string member comprising a resin.

5. The pinch sensor cable according to claim 1, wherein
the wire-shaped member is elastically deformable in the radial direction.

6. The pinch sensor cable according to claim 1, further comprising
a gap filler filling a gap between the outer circumference of the wire-shaped member and an inner surface of the sheath.

7. The pinch sensor cable according to claim 1, wherein
the first through fourth covered wires are in contact with an inner surface of the sheath.

8. The pinch sensor cable according to claim 1, further comprising
four gap fillers inside the sheath, each being arranged between two adjacent wires from the first through fourth covered wires, wherein
the first through fourth covered wires are (i) in contact with an inner surface of the sheath or (ii) spaced from the inner surface.

9. The pinch sensor cable according to claim 1, wherein
the wire-shaped member includes at least four partition walls extending between the first through fourth covered wires.

10. The pinch sensor cable according to claim 9, wherein
the at least four partition walls include four pairs of partition walls, each pair holding a corresponding one of the first through fourth covered wires.

11. The pinch sensor cable according to claim 1, wherein
one of the at least one conductive wire of each of the first through fourth covered wires is located at a center of a corresponding one of the first through fourth covered wires in the transverse cross-section.

12. The pinch sensor cable according to claim 1, wherein
at least one of the first through fourth covered wires includes two or more conductive wires as the at least one conductive wire.

13. The pinch sensor cable according to claim 1, wherein
at least one of the first through fourth covered wires includes, at the first end, a portion drawn out and exposed from the sheath.

14. A pinching detection system, comprising:
the pinch sensor cable according to claim 1;
an input pulse generator (i) coupled, at a second end of the pinch sensor cable opposite the first end, to the first covered wire and to the second covered wire and (ii) configured to repeatedly supply an input pulse between the first covered wire and the second covered wire; and
a crosstalk detector (i) coupled, at the second end, to the third covered wire and to the fourth covered wire and (ii) configured to detect crosstalk between the third covered wire and the fourth covered wire.

15. The pinching detection system according to claim 14, wherein
the pinch sensor cable is configured such that a magnitude of the crosstalk increases in response to an increase in a misalignment between the first midpoint and the second midpoint.

16. The pinching detection system according to claim 14, wherein
the pinching detection system is configured such that a magnitude of the crosstalk increases in response to an increase in a frequency of the input pulse.

17. The pinching detection system according to claim 14, wherein
the input pulse generator comprises a timer circuit.

18. The pinching detection system according to claim 14, wherein
the crosstalk detector comprises:
an operational amplifier (i) coupled to the third covered wire and to the fourth covered wire and (ii) configured to receive and amplify the crosstalk;
a rectifier circuit configured (i) to receive and rectify the crosstalk amplified and (ii) to smooth the crosstalk rectified; and
a comparator configured to compare, with a preset threshold, a magnitude of the crosstalk smoothed.

19. The pinching detection system according to claim 16, wherein
the input pulse generator and the comparator are implemented by a microcomputer.

20. The pinching detection system according to claim 14, wherein
at least one of the first through fourth covered wires includes, at the second end, a portion drawn out and exposed from the sheath.
